(19) United States
(12) Patent Application Publication
(10) Pub. No.: US 2005/0121858 A1
(43) Pub. Date: Jun. 9, 2005

(54) Support of PTFE sealing element

(76) Inventor: Lourenco Agnello Oricchio JR., Sao Paulo (BR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/979,802

(22) Filed: Nov. 3, 2004

(30) Foreign Application Priority Data
Feb. 26, 2003 (BR) PI 0300444-9

(51) Int. Cl. F16J 15/16; F16J 15/32

(52) U.S. Cl. 277/549

(57) ABSTRACT

This abstract refers to a patent of invention for sealing element pertaining to the field of sealing devices for automotive use, mainly, which was improved to provide performance superior to the similar conventional product, especially for applications involving eccentric axles or with eccentricities originated from the use or due to other reasons; this improvement consists in the association of the polytetrafluoroethylene sealing element (1), PTFE, to an elastic element (30), arranged to be tensioned whenever the PTFE sealing element (1) suffers radial deformation during the use, as well as to be distended and to accelerate the return of the PTFE sealing element (1) to the original form in conjunction with the axle or other parts sealed (20) when the deformation strengths cease.

### BACKGROUND OF THE INVENTION

1. Field of the Invention

This descriptive report refers to a patent of invention for sealing element pertaining to the field of sealing devices for automotive use, mainly, which was improved to provide performance superior to the similar conventional product, especially for applications involving eccentric axles or eccentricities originated from the use.

2. Description of the Related Art

There are available sealing devices of polytetrafluoroethylene, PTFE, used to compose radial sealing devices of axles, stems, or similar parts in automotive applications, mainly.

Concerning the good performance of the PTFE sealing element, it is relatively plastic, which implies in a slow return to its original form after having suffered radial deformation during the use. This is observed mainly when the PTFE sealing element is used in the sealing of eccentric axles or of axles presenting a certain eccentricity resulted from gaps in the project and/or gaps originated along the useful life of the product, or due to other reasons. This situation is not desired, since it allows a defective sealing.

### SUMMARY OF THE INVENTION

Thus, the invention object of this patent is intended to provide a PTFE sealing element with the solution for the problem above.

Another objective is to provide a sealing element that, in spite of resolving the problem above, is of easy manufacture.

Another objective is to provide a sealing element with convenient cost.

Therefore, in light of the problem listed above and in order to overcome it, observing the objectives listed and any others, we developed the improvement of sealing element object of this patent of invention, which basically consists in the association of the PTFE sealing element to an elastic element, which it on its turn is arranged to hasten the return of the sealing element against the surface sealed, when said sealing element is radially deformed during the use.

This manner of construction of the sealing element resolves the problem mentioned above, since it inhibits the plastic property of the PTFE, providing the element with elasticity sufficient to maintain, or return, it rapidly to the position of use, avoiding defects during the use.

On the other hand, the sealing element object hereof does not carry technical complications to the productive process, nor high manufacturing costs.

### BRIEF DESCRIPTION OF THE DRAWINGS

The drawings attached hereto refer to the improvement of the support of PTFE sealing element object hereof, where:

FIG. 1 demonstrates a sealing element in cut, composed with the sealing element according to the invention; and

FIG. 2 demonstrates another possibility for the sealing element invented.

### DESCRIPTION OF THE PREFERRED EMBODIMENTS

Pursuant to the figures aforementioned, the sealing element 1, object hereof, is made of polytetrafluoroethylene, PTFE, consisting in a circular-crown-shaped body, with: an internal section with sealing surface 2 provided with hydrodynamic sealing 3, fold intermediary section 4, and peripheral settlement section 5.

The PTFE sealing element 1, constructed as mentioned above, is used to compose sealing devices 10 destined to the radial sealing of axles, stems, or similar parts 20 of automotive mechanisms or components, mainly, or others; these sealing devices 10 basically include: main radial sealing, formed by the PTFE sealing element 1, which causes the sealing against the axle, stem, or similar part 20; rubber auxiliary sealing ring 11, which protects the main sealing against dirt; and a ring frame 12, which incorporates the main 1 and auxiliary 11 sealing.

The improvement object hereto consists in the association of the polytetrafluoroethylene sealing element 1, PTFE, with circular-crown shape and provided with hydrodynamic sealing 3 to an elastic element 30 disposed to be tensioned whenever the PTFE sealing element 1 suffers radial deformations during use, and to be extended and to accelerate the return of the PTFE sealing element to the original form against the surface sealed 20, when the deformation strengths cease.

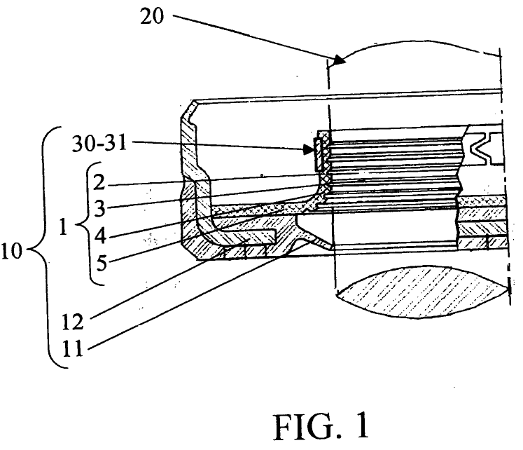

In one possibility of execution (FIG. 1), said elastic element 30 is basically composed of a spring steel open ring 31 incorporated to the external surface 4 of the PTFE sealing element 1 opposed to the sealing surface 2, provided with hydrodynamic sealing 3, which provides sealing against the surface of the axle, stem or other parts 20.

Thus, when the sealing surface 2 of the PTFE sealing element 1 is deformed radially outwards due to strengths resulted from the eccentricity of the axle, stem or other part 20, the spring steel open ring 31 is correspondently tensioned. Upon the end of the strengths of radial deformation on the sealing surface 2 of the PTFE sealing element 1, spring steel open ring 31 distends and returns rapidly the PTFE sealing element 1 to its original form in conjunction with the axle or other part 20, thus avoiding the memory of the PTFE from delaying the return and allowing a loss of sealing.

Within the basic construction aforementioned, the PTFE sealing element object hereof may present modifications related to dimensions, constructive details, and/or functional configuration without affecting the scope of the protection requested.

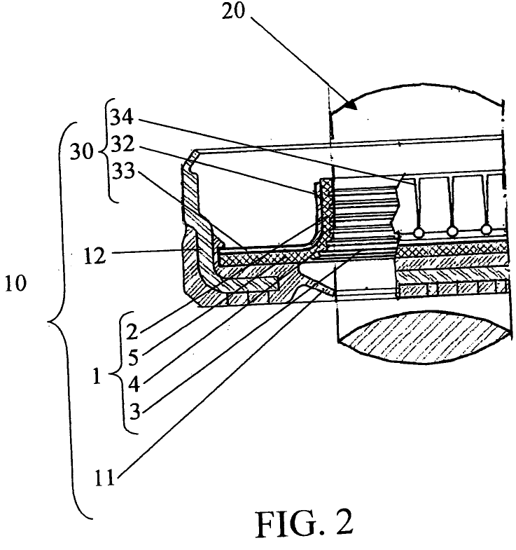

Considering the aforementioned, instead of the elastic element 30 being constructed by an open ring 31, as of the version described above, said elastic element 30 may consist (FIG. 2) of a spring steel ring piece 32-33 with profile substantially equal to that of the PTFE sealing element 1, disposed in the external surface thereof and basically composed of: axial tubular section 32 disposed adjacently to the external surface 4 of the PTFE sealing element 1 in opposition to the sealing surface itself 2; and by radial flange 33 turned outwards in relation to the axial tubular section 32 and adjacent to the region of the external surface 4 of the peripheral settlement section 5 of the PTFE sealing element 1; said axial tubular section 32 is provided with longitudinal cuts 34, extended from its free edge to the vertex region in relation to flange 33.

1. “IMPROVEMENT OF THE SUPPORT OF PTFE SEALING ELEMENT”, made of polytetrafluoroethylene, PTFE, destined to the radial sealing of axles, stems, or other parts (20), which basically comprises: circular-crown-shaped body, with: an internal section with sealing surface (2) provided with hydrodynamic sealing (3); fold intermediary section (4); and peripheral settlement section (5), characterized by the fact of consisting in the association of the polytetrafluoroethylene sealing element (1), PTFE, to an elastic element (30) arranged to be tensioned when the PTFE sealing element (1) is under radial deformation during the use, and to be distended and to accelerate the return of the PTFE sealing element (1) to the original form in conjunction with the axle or other parts sealed (20), when the deformation strengths cease.

2. “IMPROVEMENT OF THE SUPPORT OF PTFE SEALING ELEMENT”, as of claim 1, characterized by the fact that the elastic element (30) basically comprises a spring steel open ring (31) incorporated to external surface (4) of the PTFE sealing element (1) in opposition to the sealing surface (2) provided with hydrodynamic (3), sealed against the surface of the axle, stem, or other parts (20).

3. “IMPROVEMENT OF THE SUPPORT OF PTFE SEALING ELEMENT”, as of claim 1, characterized by the fact that the elastic element (30) is comprised by a spring steel ring piece (32)-(33) with profile substantially equal to that of the PTFE sealing element (1), and settled in the external surface thereof.

4. “IMPROVEMENT OF THE SUPPORT OF PTFE SEALING ELEMENT”, as of claim 3, characterized by the fact that the spring steel ring piece (32)-(33) is basically composed of: axial tubular section (32) disposed adjacently to the external surface (4) of the PTFE sealing element (1) in opposition to the sealing surface (2); and of a radial flange (33) turned outwards in relation to the axial tubular section (32), and adjacent to the region of the external surface (4) of the peripheral settlement section (5) of the PTFE sealing element (1); this axial tubular section (32) is provided with longitudinal cuts (34) along its free edge near the vertex region in relation to the flange (33).
